(19) United States
(12) Patent Application Publication
(10) Pub. No.: US 2025/0083585 A1
(43) Pub. Date: Mar. 13, 2025

(54) SYSTEM AND METHOD FOR INSTALLATION OF PHOTOVOLTAIC PANELS

(71) Applicant: Ingher Investments, LLC, Des Moines, IA (US)

(72) Inventor: Jaime Arturo Torres Morales, Biobio (CL)

(21) Appl. No.: 18/826,522

(22) Filed: Sep. 6, 2024

Related U.S. Application Data
(60) Provisional application No. 63/581,800, filed on Sep. 11, 2023.

(51) Int. Cl. B60P 1/54; B66C 1/02; H02S 20/10

(52) U.S. Cl. CPC B60P 1/5433; B66C 1/0243; H02S 20/10

(57) ABSTRACT

In one or more arrangements, a system for installation of photovoltaic panels is presented. In one or more arrangements, the system includes a suction head assembly and a lift assembly operably connected to a mobile platform. In one or more arrangements, the suction head assembly is configured to selectively connect with a photovoltaic panel held in a rack on the mobile platform. In one or more arrangements, the lift assembly is configured to facilitate movement of the suction head to facilitate movement and positioning of the photovoltaic panels from the rack to a position for installation.

### REFERENCE TO RELATED PATENT APPLICATION(S)

This patent application claims priority to U.S. Provisional Patent Application 63/581,800 filed Sep. 11, 2023, and titled “SYSTEM AND METHOD FOR INSTALLATION OF PHOTOVOLTAIC PANELS”, which is hereby fully incorporated by reference herein in its entirety.

### FIELD OF THE DISCLOSURE

This disclosure generally relates to photovoltaic systems. More specifically and without limitation, this disclosure relates to installation of photovoltaic panels.

### OVERVIEW OF THE DISCLOSURE

Photovoltaic (solar) systems have become a cost competitive means for energy generation. Increasingly, photovoltaic systems are installed in large field deployed arrays. For example, many farmers have portions of land that may be unproductive for growing for various reasons (grade, soil characteristics, etc.). Increasingly, many farmers have found it advantageous to deploy arrays of photovoltaic panels on such portions of unproductive land.

For field based installation, photovoltaic systems are most typically constructed from a plurality of rectangular photovoltaic panels mounted on respective support structures and electrically inter-connected. Most typically, the support structures are designed to permit the panels to be oriented at an angle so they may collect the optimal amount of energy from sunlight.

However, for various reasons related to cost, manufacture, efficiency, shipping and/or other reasons, photovoltaic panels tend to be large and heavy. Due to the size and weight, installation of photovoltaic panels can be difficult and may require several workers to move, position, and mount panels on support structures for installation.

Therefore, for all the reasons stated above, and all the reasons stated below, there is a need in the art for an improved mounting system for photovoltaic panels.

Thus, it is a primary object of the disclosure to provide a mounting system for installation of photovoltaic panels that improves upon the state of the art.

Another object of the disclosure is to provide a system for installation of photovoltaic panels that assists in the movement and positioning of photovoltaic panels for mounting on support structures.

Yet another object of the disclosure is to provide a system for installation of photovoltaic panels that is efficient for installation.

Another object of the disclosure is to provide a system for installation of photovoltaic panels that can facilitate installation by a single person.

Yet another object of the disclosure is to provide a system for installation of photovoltaic panels that operably connects with photovoltaic panels using a vacuum connection.

Another object of the disclosure is to a system for installation of photovoltaic panels that is easy to use.

Yet another object of the disclosure is to provide a system for installation of photovoltaic panels that can be deployed on a transportation vehicle.

Another object of the disclosure is to provide a system for installation of photovoltaic panels that is configured to facilitate movement of photovoltaic panels from a rack in a transportation vehicle to a position adjacent support structures for installation.

Yet another object of the disclosure is to provide a system for installation of photovoltaic panels that is robust.

Another object of the disclosure is to provide a system for installation of photovoltaic panels that is durable.

Yet another object of the disclosure is to a system for installation of photovoltaic panels that has a long useful life.

Another object of the disclosure is to provide a system for installation of photovoltaic panels that works effectively.

Yet another object of the disclosure is to provide a system for installation of photovoltaic panels that is high quality.

These and other objects, features, or advantages of the disclosure will become apparent from the specification, figures and claims.

### SUMMARY OF THE DISCLOSURE

In one or more arrangements, a system for installation of photovoltaic panels is presented. In one or more arrangements, the system includes a suction head assembly and a lift assembly operably connected to a mobile platform. In one or more arrangements, the suction head assembly is configured to selectively connect with a photovoltaic panel held in a rack on the mobile platform. In one or more arrangements, the lift assembly is configured to facilitate movement of the suction head to facilitate movement and positioning of the one of the plurality of photovoltaic panels from the rack to a position for installation.

### BRIEF DESCRIPTION OF THE DRAWINGS

FIG. 1 shows a rear view of a system for installation of photovoltaic panels, in accordance with one or more arrangements.

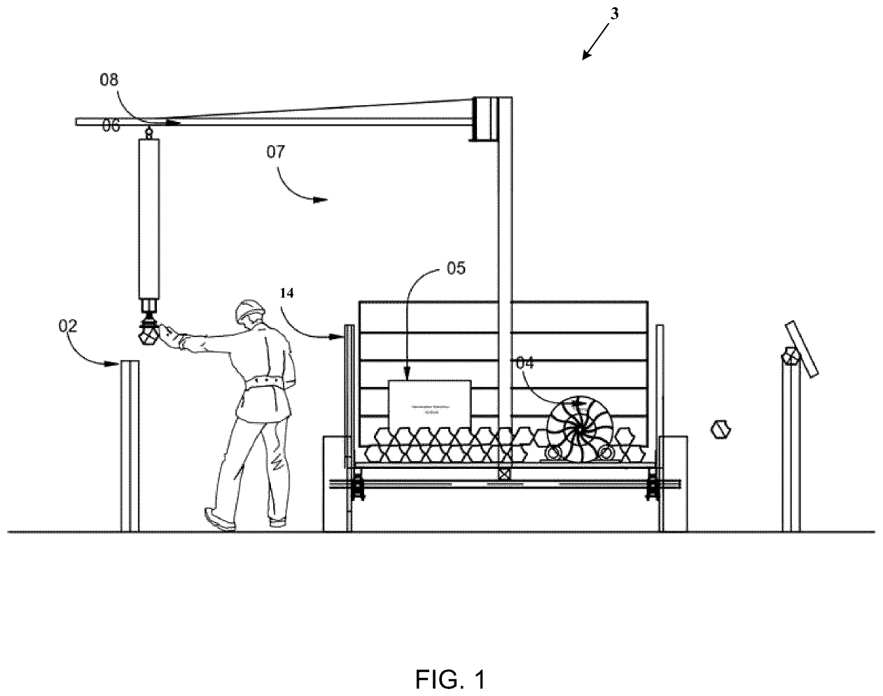

FIG. 2 shows a rear view of a system for installation of photovoltaic panels, in accordance with one or more arrangements.

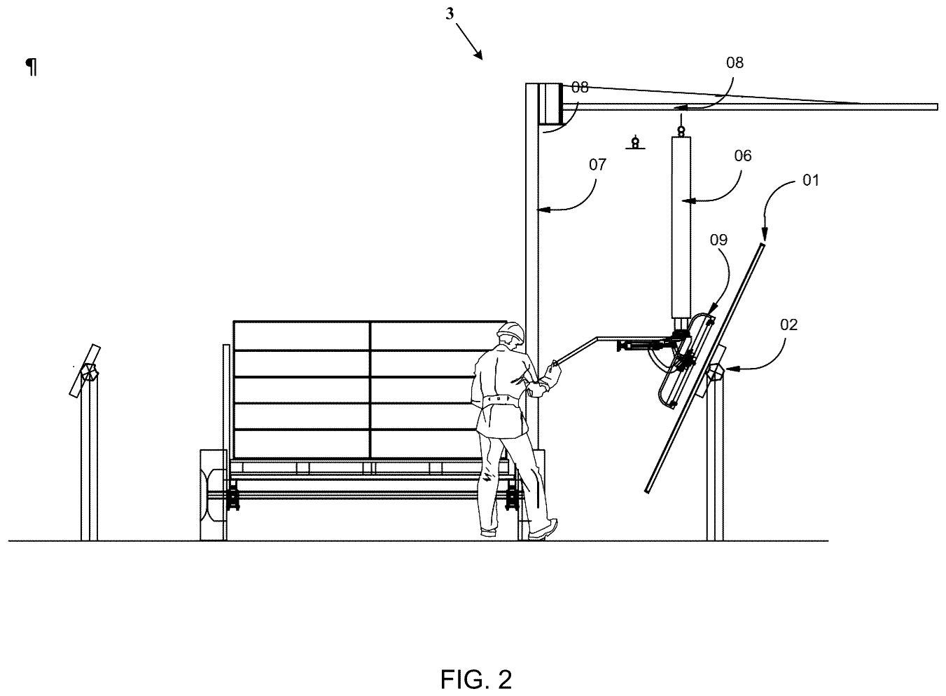

FIG. 3 shows a left side view of a system for installation of photovoltaic panels, in accordance with one or more arrangements.

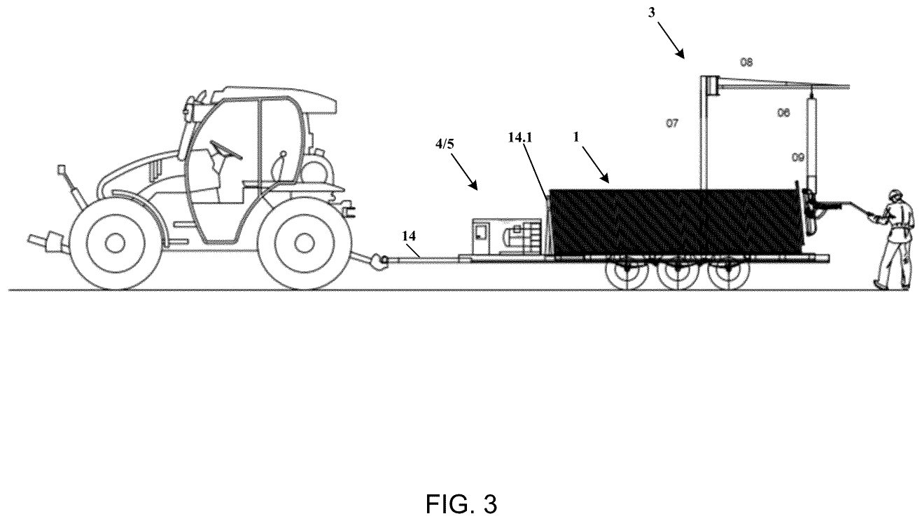

FIG. 4 shows a right side view of a system for installation of photovoltaic panels, in accordance with one or more arrangements.

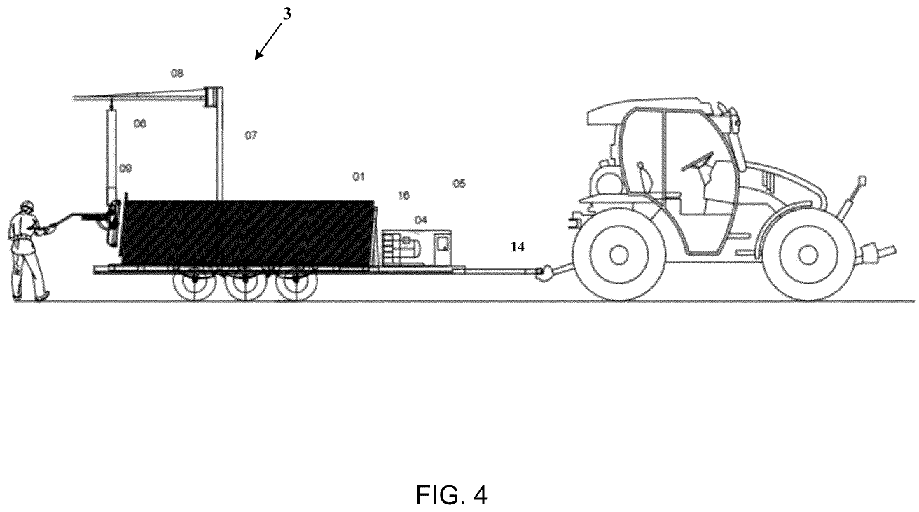

FIG. 5 shows a top view of a system for installation of photovoltaic panels, in accordance with one or more arrangements.

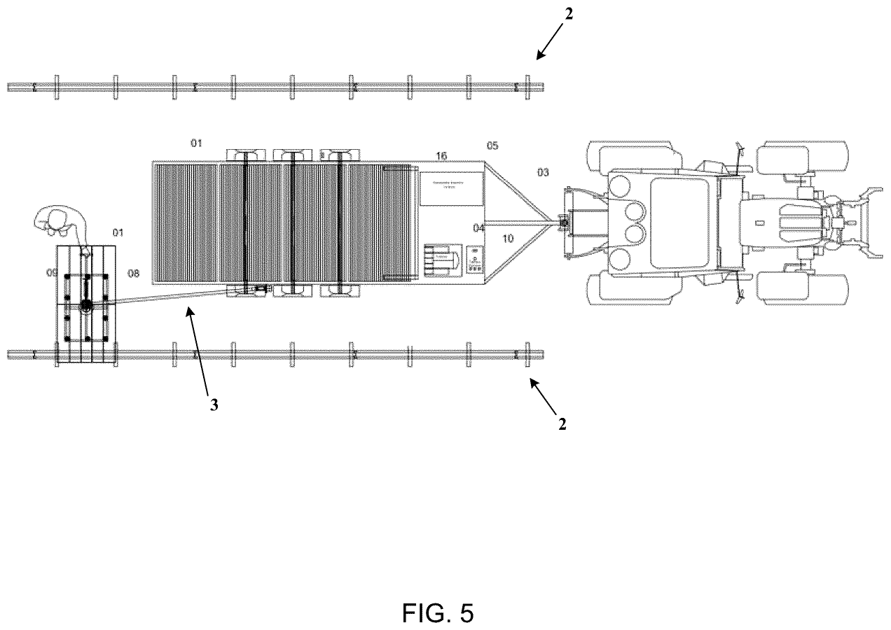

FIG. 6 shows a bottom view of a system for installation of photovoltaic panels, in accordance with one or more arrangements.

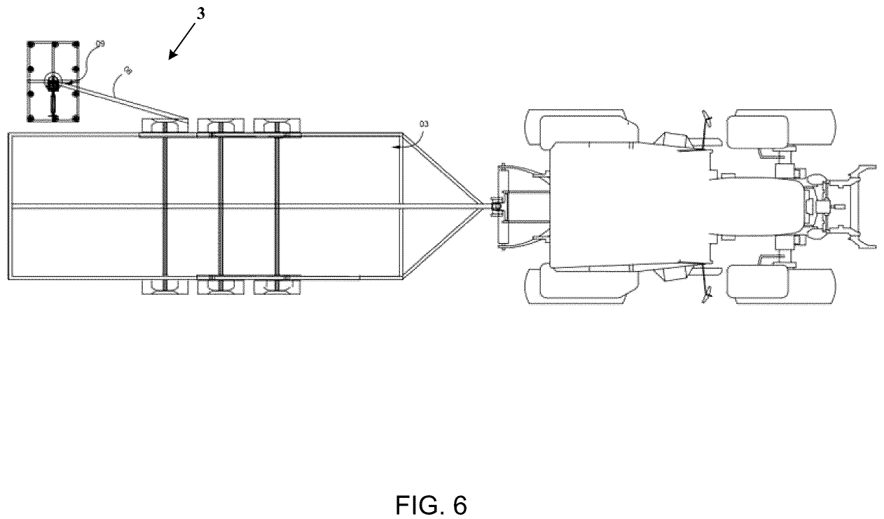

FIG. 7 shows an upper left rear perspective view of a system for installation of photovoltaic panels, in accordance with one or more arrangements.

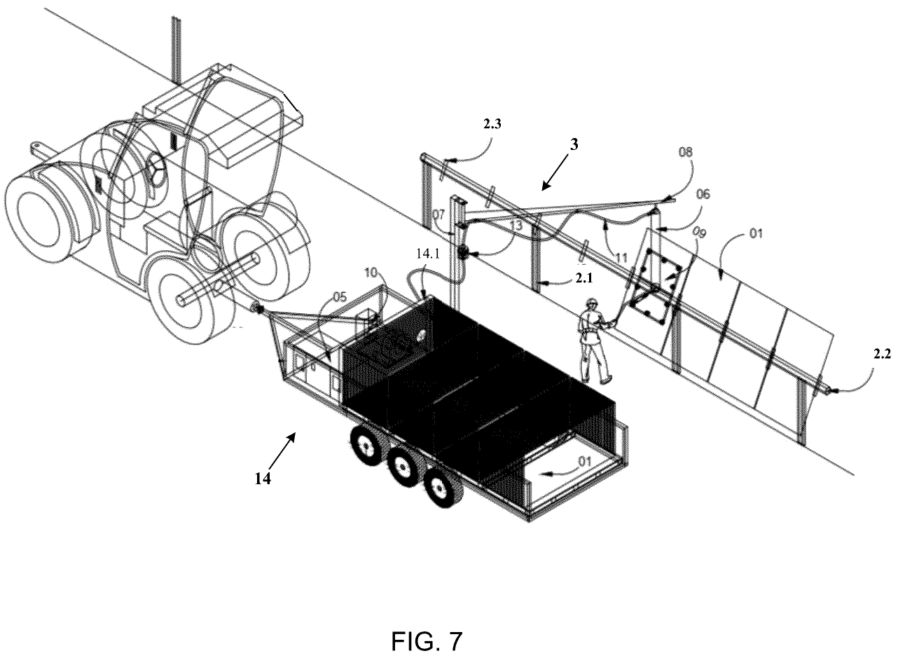

FIG. 8 shows an exploded side view of a suction head assembly for use with a system for installation of photovoltaic panels, in accordance with one or more arrangements.

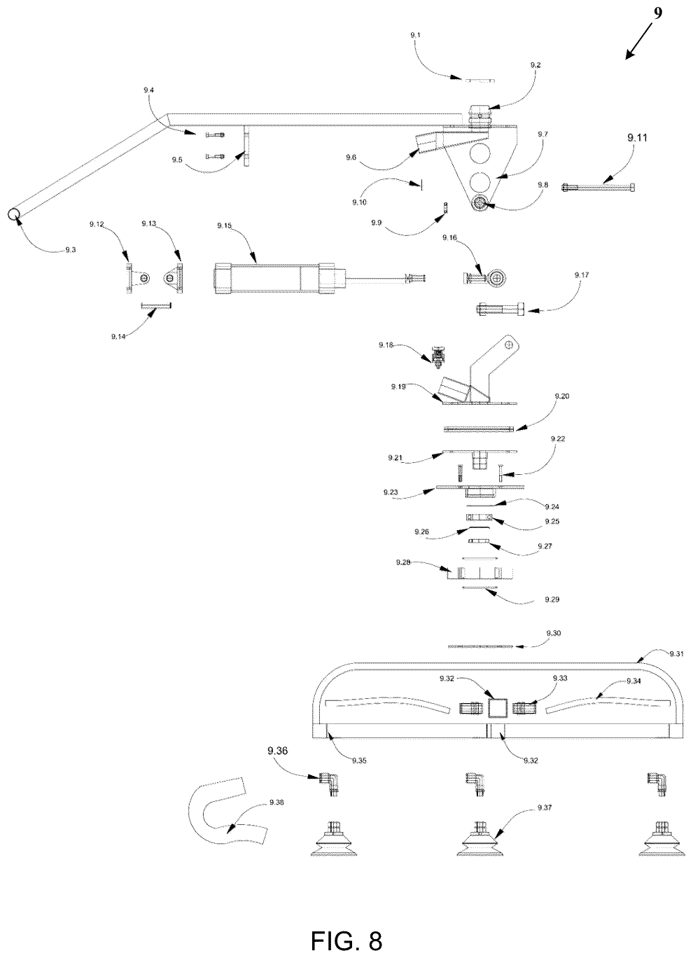

FIG. 9 shows a bottom view of a suction head assembly for use with a system for installation of photovoltaic panels, in accordance with one or more arrangements.

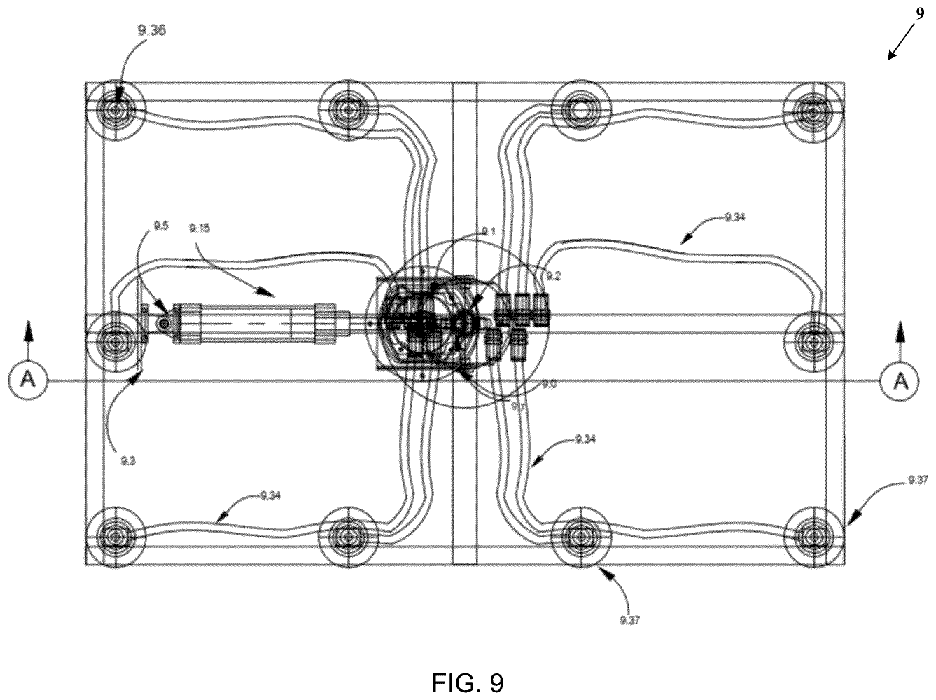

FIG. 10 shows a side view of a suction head assembly for use with a system for installation of photovoltaic panels, in accordance with one or more arrangements.

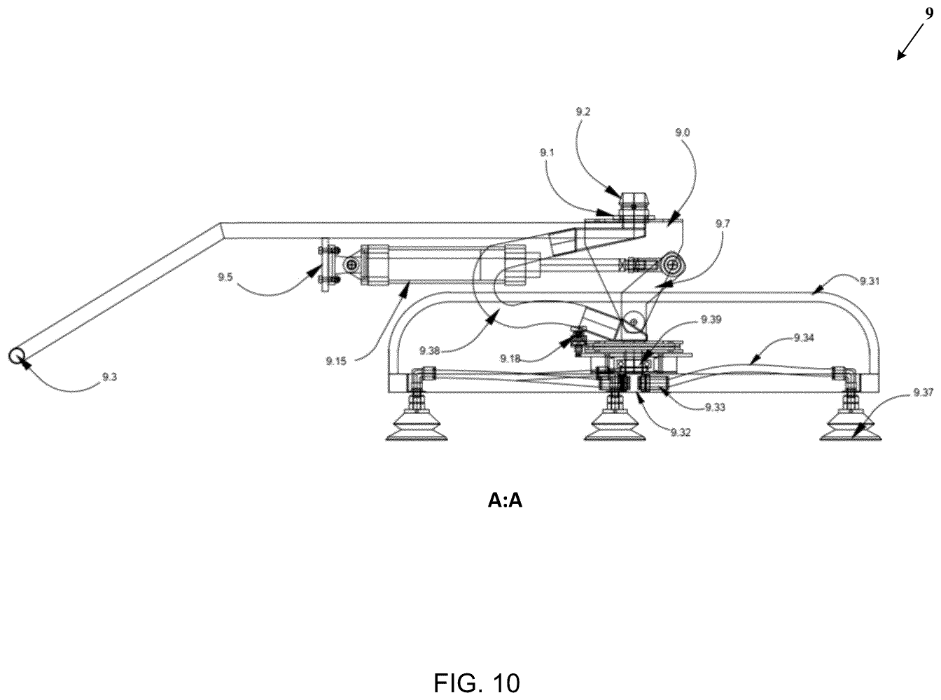

FIG. 11 shows a flowchart of an example process for use of a system for installation of photovoltaic panels, in accordance with one or more arrangements.

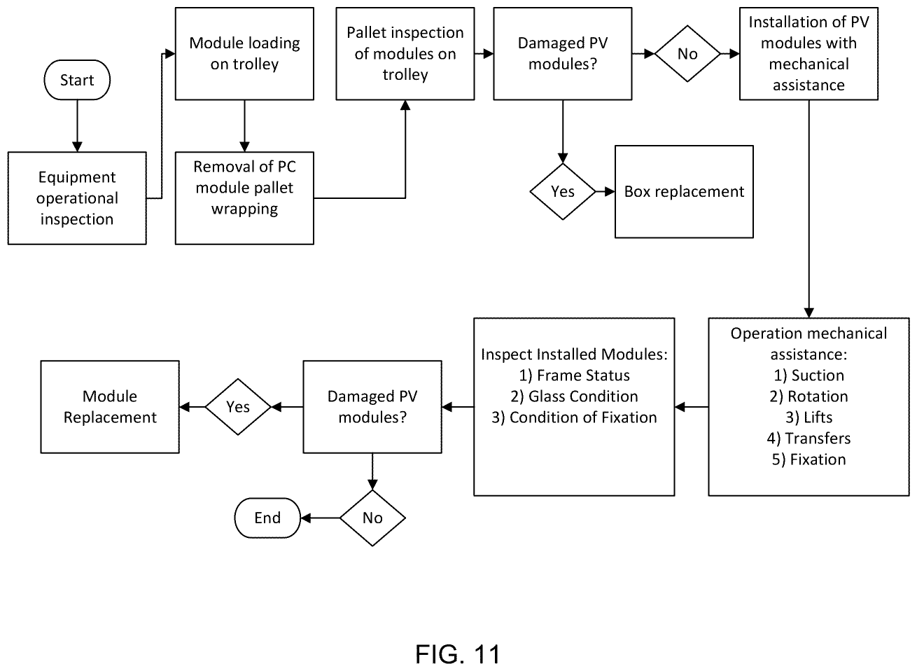

FIG. 12 shows a right side view of a system for installation of photovoltaic panels, in accordance with one or more arrangements; the view showing the system being repositioned for pickup of a photovoltaic panel.

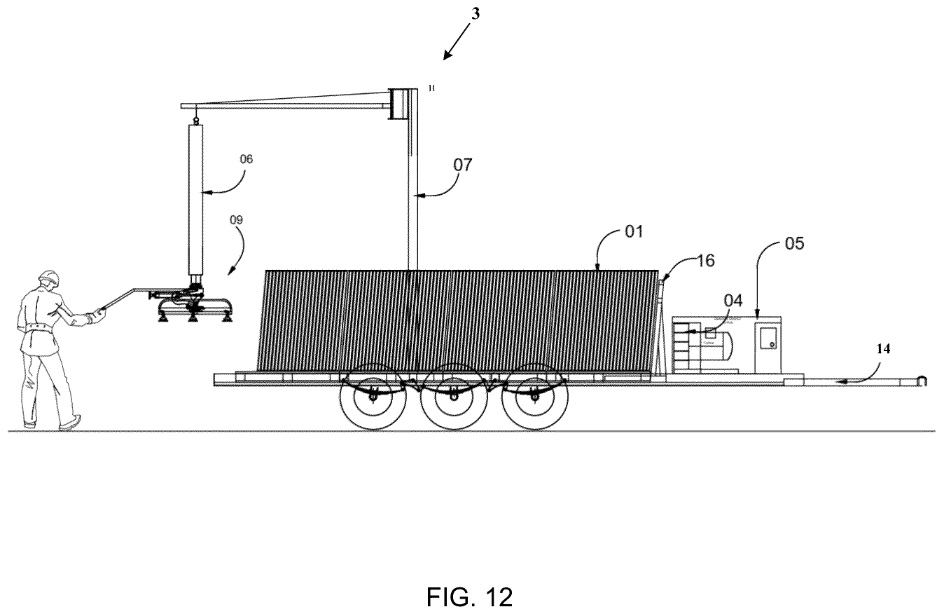

FIG. 13 shows a right side view of a system for installation of photovoltaic panels, in accordance with one or more arrangements; the view showing the system being positioned for suction head assembly to connect with a photovoltaic panel.

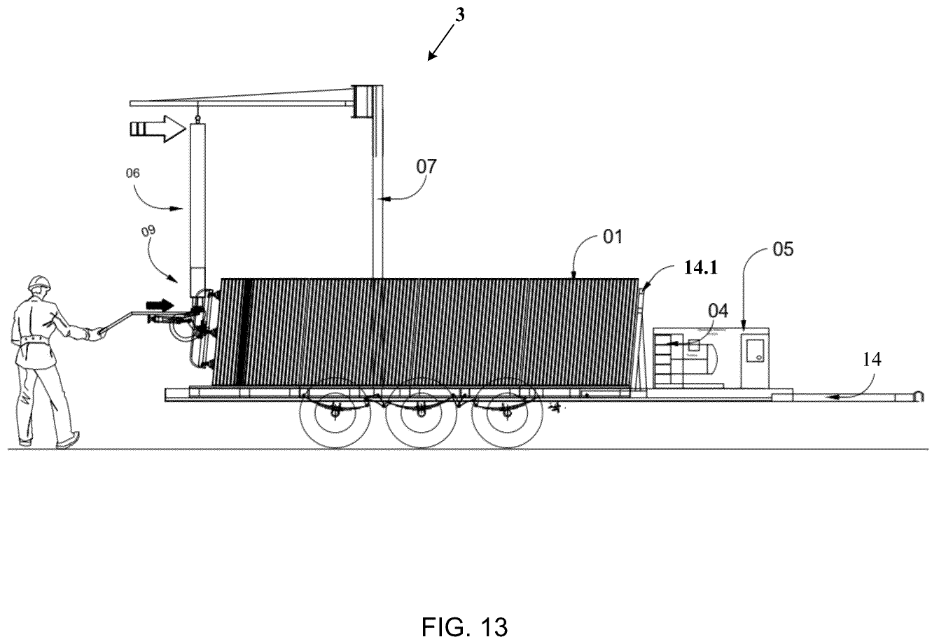

FIG. 14 shows a right side view of a system for installation of photovoltaic panels, in accordance with one or more arrangements; the view showing the system being used to move a photovoltaic panel for installation.

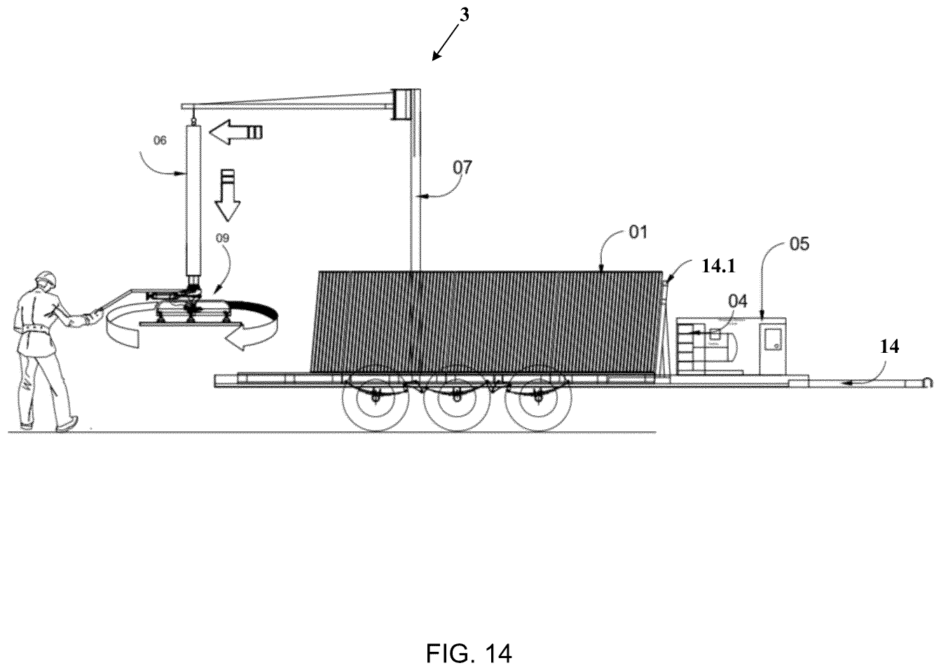

FIG. 15 shows a rear view of a system for installation of photovoltaic panels, in accordance with one or more arrangements; the view showing the system being used to move a photovoltaic panel for installation.

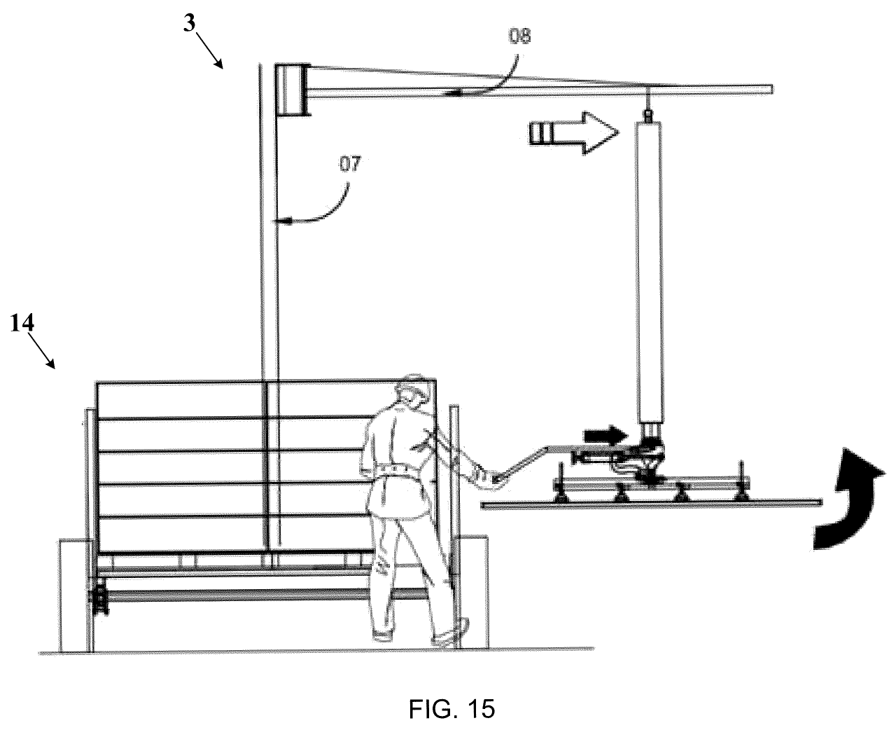

FIG. 16 shows a rear view of a system for installation of photovoltaic panels, in accordance with one or more arrangements; the view showing the system being used to pivot a photovoltaic panel into orientation for installation.

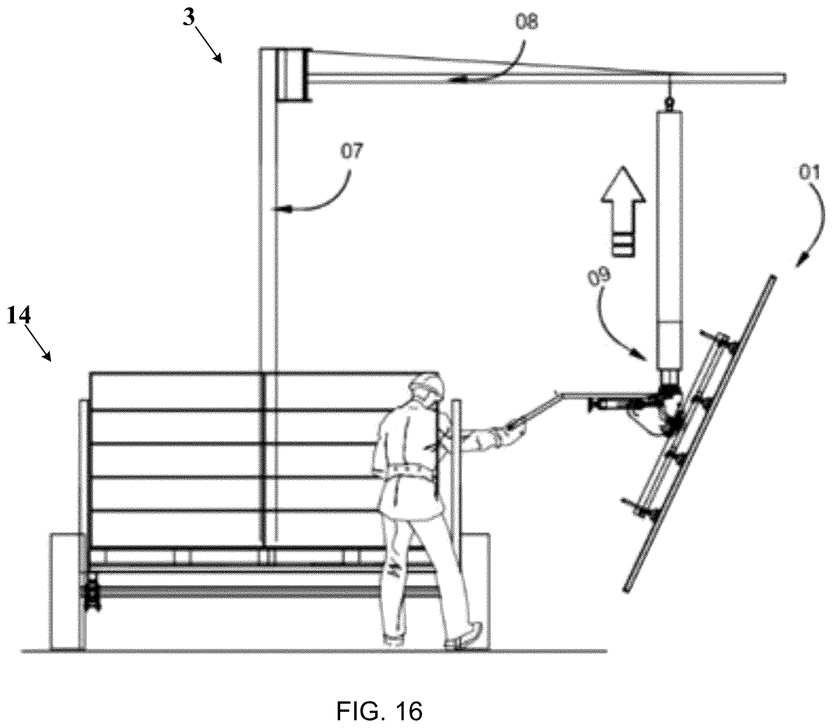

FIG. 17 shows a rear view of a system for installation of photovoltaic panels, in accordance with one or more arrangements; the view showing the system being used to move a photovoltaic panel into final position for installation.

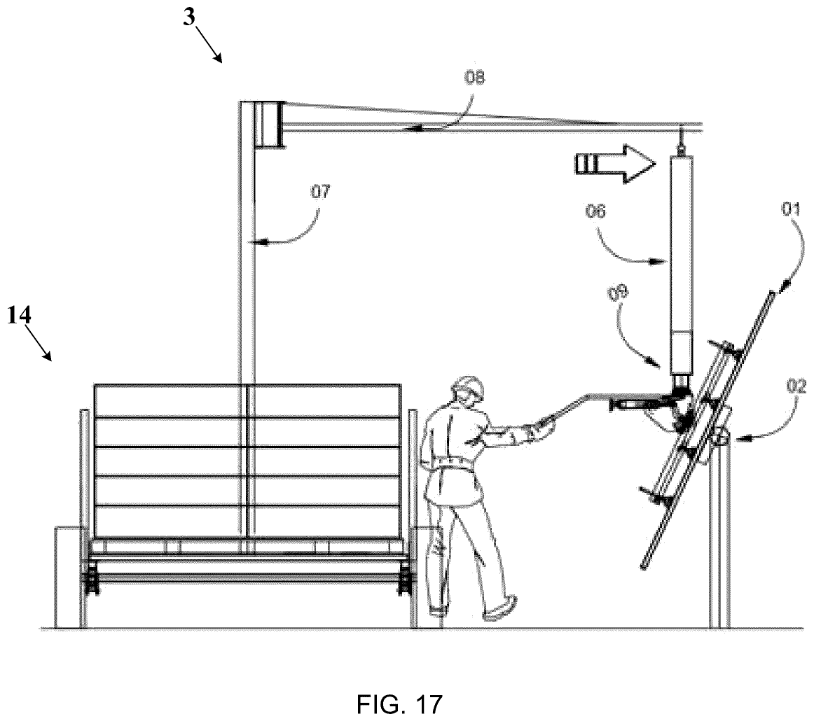

FIG. 18 shows a diagram of a control system for used with a system for installation of photovoltaic panels, in accordance with one or more arrangements.

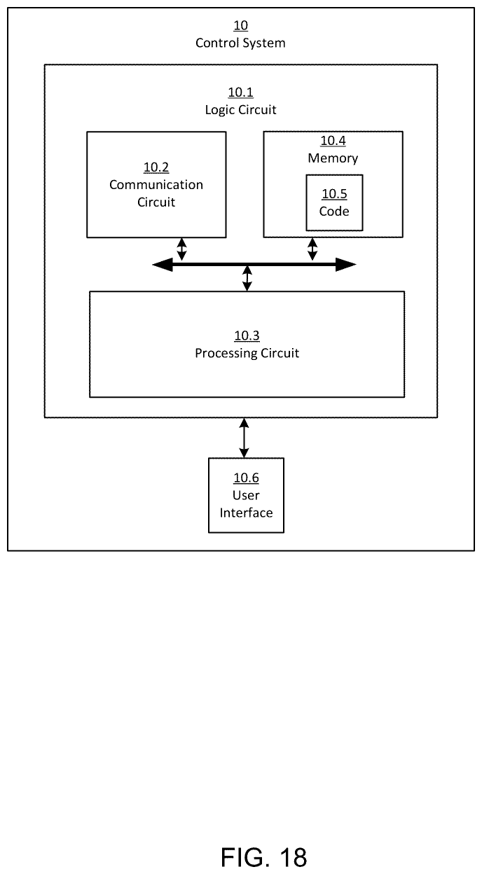

### DETAILED DESCRIPTION OF THE DISCLOSURE

In the following detailed description of the embodiments, reference is made to the accompanying drawings which form a part hereof, and in which is shown by way of illustration specific embodiments in which the disclosure may be practiced. The embodiments of the present disclosure described below are not intended to be exhaustive or to limit the disclosure to the precise forms in the following detailed description. Rather, the embodiments are chosen and described so that others skilled in the art may appreciate and understand the principles and practices of the present disclosure. It will be understood by those skilled in the art that various changes in form and details may be made without departing from the principles and scope of the invention. It is intended to cover various modifications and similar arrangements and procedures, and the scope of the appended claims therefore should be accorded the broadest interpretation so as to encompass all such modifications and similar arrangements and procedures. For instance, although aspects and features may be illustrated in and/or described with reference to certain figures and/or embodiments, it will be appreciated that features from one figure and/or embodiment may be combined with features of another figure and/or embodiment even though the combination is not explicitly shown and/or explicitly described as a combination. In the depicted embodiments, like reference numbers refer to like elements throughout the various drawings.

It should be understood that any advantages and/or improvements discussed herein may not be provided by various disclosed embodiments, and/or implementations thereof. The contemplated embodiments are not so limited and should not be interpreted as being restricted to embodiments that provide such advantages and/or improvements. Similarly, it should be understood that various embodiments may not address all or any objects of the disclosure and/or objects of the invention that may be described herein. The contemplated embodiments are not so limited and should not be interpreted as being restricted to embodiments that address such objects of the disclosure and/or invention. Furthermore, although some disclosed embodiments may be described relative to specific materials, embodiments are not limited to the specific materials and/or apparatuses but only to their specific characteristics and capabilities and other materials and apparatuses can be substituted as is well understood by those skilled in the art in view of the present disclosure. Moreover, although some disclosed embodiments may be described in the context of window treatments, the embodiments are not so limited. In is appreciated that the embodiments may be adapted for use in other applications which may be improved by the disclosed structures, arrangements and/or methods.

It is to be understood that the terms such as “left, right, top, bottom, front, back, side, height, length, width, upper, lower, interior, exterior, inner, outer, and the like as may be used herein, merely describe points of reference and do not limit the present invention to any particular orientation and/or configuration.

As used herein, “and/or” includes all combinations of one or more of the associated listed items, such that “A and/or B” includes “A but not B,” “B but not A,” and “A as well as B,” unless it is clearly indicated that only a single item, subgroup of items, or all items are present. The use of “etc.” is defined as “et cetera” and indicates the inclusion of all other elements belonging to the same group of the preceding items, in any “and/or” combination(s).

As used herein, the singular forms “a,” “an,” and “the” are intended to include both the singular and plural forms, unless the language explicitly indicates otherwise. Indefinite articles like “a” and “an” introduce or refer to any modified term, both previously-introduced and not, while definite articles like “the” refer to a same previously-introduced term; as such, it is understood that “a” or “an” modify items that are permitted to be previously-introduced or new, while definite articles modify an item that is the same as immediately previously presented. It will be further understood that the terms “comprises,” “comprising,” “includes,” and/or “including,” when used herein, specify the presence of stated features, characteristics, steps, operations, elements, and/or components, but do not themselves preclude the presence or addition of one or more other features, characteristics, steps, operations, elements, components, and/or groups thereof, unless expressly indicated otherwise. For example, if an embodiment of a system is described at comprising an article, it is understood the system is not limited to a single instance of the article unless expressly indicated otherwise, even if elsewhere another embodiment of the system is described as comprising a plurality of articles.

It will be understood that when an element is referred to as being “connected,” “coupled,” “mated,” “attached,” “fixed,” etc. to another element, it can be directly connected to the other element, or intervening elements may be present. In contrast, when an element is referred to as being “directly connected,” “directly coupled,” etc. to another element, there are no intervening elements present. Other words used to describe the relationship between elements should be interpreted in a like fashion (e.g., “between” versus “directly between,” “adjacent” versus “directly adjacent,” etc.). Similarly, a term such as “communicatively connected” includes all variations of information exchange and routing between two electronic devices, including intermediary devices, networks, etc., connected wirelessly or not.

It will be understood that, although the ordinal terms “first,” “second,” etc. may be used herein to describe various elements, these elements should not be limited to any order by these terms. These terms are used only to distinguish one element from another; where there are “second” or higher ordinals, there merely must be that many number of elements, without necessarily any difference or other relationship. For example, a first element could be termed a second element, and, similarly, a second element could be termed a first element, without departing from the scope of example embodiments and/or methods.

Similarly, the structures and operations discussed below may occur out of the order described and/or noted in the figures. For example, two operations and/or figures shown in succession may in fact be executed concurrently or may sometimes be executed in the reverse order, depending upon the functionality/acts involved. Similarly, individual operations within example methods described below may be executed repetitively, individually, and/or sequentially, to provide looping and/or other series of operations aside from single operations described below. It should be presumed that any embodiment and/or method having features and functionality described below, in any workable combination, falls within the scope of example embodiments.

As used herein, various disclosed embodiments may be primarily described in the context of photovoltaic systems. However, the embodiments are not so limited. It is appreciated that the embodiments may be adapted for use in other applications which may be improved by the disclosed structures, arrangements and/or methods. The system is merely shown and described as being used in the context of photovoltaic systems for ease of description and as one of countless example applications.

Turning now to the figures, a system for connecting various components of a system for installation of photovoltaic panels is presented, as is shown as one example.

### System 100

With reference to the figures, a system for installation of photovoltaic panels 100 is presented (or simply system 10). In the example context of photovoltaic systems, in one or more arrangements, system 100 is configured to facilitate installation of photovoltaic panels 1 on support structures 2. In the arrangements shown, as some non-limiting examples, system 100 is configured for use on a mobile platform 14 having a rack 14.1 for storage and/or transportation of a plurality of photovoltaic panels 1. In one or more arrangements, system 100 includes a lift assembly 3, a suction head assembly 9, a vacuum 4, a power source 5, and a control system 10 among other components.

### Photovoltaic Panels 1

Photovoltaic panels 1 are formed of any suitable size, shape, and design and are configured to generated electricity from light. In the arrangement, shown, as one example, photovoltaic panels 1 generally include a sheet of photovoltaic cells and a support frame among other components. In this example arrangement, light incident on a front surface of the photovoltaic cells generate an electric current across a set of output electric terminals (not shown). In some arrangements, photovoltaic panels 1 may be formed of a plurality of smaller photovoltaic panels 1 that are electrically and physically connected together to form larger photovoltaic panels 1. Photovoltaic panels 1 generally have a rectangular planar shape. However, the arrangements are not so limited. Rather, it is contemplated that in some various arrangements, the sheet of photovoltaic cells 24 may have various different shapes including but not limited to: square, rectangular, circular, triangular, pentagonal, hexagonal, octagonal, other polygonal, or any other shape. In this example arrangement, light incident on a front surface of the photovoltaic panels 1 generate an electric current across a set of output electric terminals (not shown).

### Support Structure 2

Support structure 2 is formed of any suitable size, shape, and design and is configured to facilitate mounting and support of photovoltaic panels 1 for operation. In the arrangement shown, as one example, support structure 2 is configured to facilitate ground mount installation of one or more photovoltaic panels 1. In the arrangement shown, as one example, support structure 2 includes a set posts 2.1, cross bars 2.2 extending between posts 2.1 and brackets 2.3 connected to the cross bars 2.2 and configured to facilitate mounting of photovoltaic panels 1 to the support structure.

However, the arrangements are not so limited. Rather, it is contemplated that in some various arrangements, support structure 2 may be adapted to facilitate mounting of photovoltaic panels 1 using various methods and means and in various locations including but not limited to, for example, installation on the ground and/or on installation on roofs, walls, doors, or other components of various different structures (e.g., homes, retail/industrial buildings, barns, grain bins, and/or any other structure).

### Mobile Platform 14

Mobile platform 14 is formed of any suitable size, shape, and design and are configured to facilitate transportation of system 100, rack 14.1, photovoltaic panels 1 and/or other various components. In one or more arrangements, lift assembly 3, suction head assembly 9, vacuum 4, a power source 5, and/or a control system 10, among other components, are operably connected to the mobile platform 14.

In one or more arrangements, as is shown, mobile platform 14 is a trailer platform that is towed behind a vehicle (e.g., a tractor). However, the arrangements are not so limited. Rather, it is contemplated that in some various arrangements, mobile platform may be implemented using various methods and/or means for transportation including but not limited to, for example, trailers, semi-trailers, rail-cars, and/or other towed vehicles, carts, self-propelled vehicles (e.g. trucks, pickups, vans, construction vehicles, agricultural vehicles (e.g. tractors, combines, etc.), tracked vehicles, or any other method and/or means for transportation. In one or more arrangements, a rack 14.1 is positioned on mobile platform 14. Rack 14.1 is formed of any suitable size, shape, and design and are configured to securely hold photovoltaic panels 1 for storage and/or transportation to locations for installation. In one or more arrangements, rack 14.1 is configured, arranged, and positioned to permit system 100 to remove individual photovoltaic panels 1 from rack 14.1 and move the panels 1 outward from mobile platform for installation (e.g., on a support structure 2).

### Lift Assembly 3

Lift assembly 3 is formed of any suitable size, shape, and design and are configured to operably connect with suction head assembly 9 and facilitate movement of suction head assembly 9 to facilitate removal and repositioning of photovoltaic panels 1 from rack 14.1 for installation. In the arrangement shown, as one example, lift assembly 3 includes a pillar 7, an arm 8, and a lifting sleeve 6 among other components. In one or more arrangements, pillar 7, arm 8, and lifting sleeve 6 are configured to work together to apply a lifting force to suction head assembly 9 when attached to a photovoltaic panel 1 to permit a worker to easily manually move and/or position photovoltaic panels 1 for installation (e.g. using handle(s)). In one or more arrangements, the lifting force provided by the list assembly operates as a counterbalance to the weight of the photovoltaic panels 1, suction head assembly 9, and/or applicable components of lift assembly 3 (e.g., arm 8 and/or lifting sleeve 6) so that a photovoltaic panel 1 is effectively weightless from the perspective of an installer. That is an installer may more and/or reposition photovoltaic panels 1 held by the suction head assembly 9 with little effort and photovoltaic panel 1 will effectively remain in place after being moved/repositioned so the installer may engage in other installation tasks (e.g., connecting the photovoltaic panel 1 to the support structure 2). Additionally or alternatively, in some arrangement, pillar 7, arm 8, and lifting sleeve 6 may be motor controlled or otherwise actuated to facilitate automated/controlled mechanized movement and/or positioning of photovoltaic panels 1 for installation.

In some various arrangements, lift assembly 3 may utilize various methods and/or means to generate lifting force and/or movement including but not limited to, for example, one or more springs, gas pistons, gas springs, hydraulic pistons, actuators, solenoids, pneumatic members, motors, and/or any other force generating means or combination thereof. Additionally or alternatively, in one or more arrangements lift assembly 3 may include various devices such as frictional clamps, clutch plates, or the like to restrict movement of lift assembly and/or suction head assembly 9, for example, to hold photovoltaic panel 1 in place after it is moved/repositioned.

### Suction Head Assembly 9

Suction head assembly 9 is formed of any suitable size, shape, and design and are configured to operably connect with lift assembly 3 and facilitate secure connection with photovoltaic panels 1 to facilitate movement and repositioning of photovoltaic panels 1 for installation.

In one or more arrangements shown, as one example, suction head assembly 9 includes: rubber seals 9.1 and 9.29, a docking system 9.2, a grip handle 9.3, a clamping bolt 9.4, a pneumatic cylinder base support 9.5, a nozzle 9.6, a joint support 9.7, a bearing chamber 9.8, a bearing 9.9, a bearing safe 9.10, a dowel bolt 9.11, a metal side support 9.12, a metal tilting support 9.13, a cylinder pin 9.14, a pneumatic cylinder 9.15. a shank hole 9.16, a swing arm bolt 9.17, a hub 9.18, a turning plate 9.19, packing 9.20, fast couplings 9.21, hex head bolts 9.22, a rotor disc 9.23, rubber stamps 9.24 and 9.26, a 360 inner bearing 9.25, a key 9.27, a bearing housing 9.28, a connection plate 9.30, a head turning handle 9.31, a vacuum chamber 9.32, a cylindrical connector 9.33, pneumatic tubes 9.34, a support structure 9.35 (e.g., a metal profile), a 90 degree tubing connector 9.36, suction cups 9.37, and a flexible hose connector 9.38, among other components.

In one or more arrangements, as one example, the suction head assembly 9 includes a support system 9.32 developed from metal profiles or similar structure. This is connected at the top to a docking system 9.2 that allows the operably connection between the control unit and the retractable lifting sleeve 06 of the lift assembly. In this example, a pneumatic cylinder 9.15 is installed between a control knob and the grip handle 9.3, and are connected by metal supports 9.13, which through a projecting piston rod is connected to a turning plate 9.19. In this illustrative example, turning plate 9.19 allows turning up to 90° in the direction of the y-axis. In addition, in this example, a rotor disc 9.23 graduated every 90° allows a controlled 360° rotation in the “x” axis direction.

In this example arrangement, the air circulation system of the suction head (09) includes a variable number of suction cups 9.37 to facilitate connection with photovoltaic panels 1. In some various arrangements, suction cups 9.37 may be selected to have various different sizes as may be required for the type of work and structure of the photovoltaic panels 1 (or other items) to be moved by the suction head assembly 9. In operation, vacuum 4 pulls air in through the suction cups 9.37 from the environment and through the lifting sleeve 06 via pneumatic tubes 9.34 to create a vacuum connection between suction cups 9.37 and a surface of photovoltaic panels 1.

However, the arrangements are not so limited. Rather, it is contemplated that in some arrangements, various one of these components (or combinations of these components) may be implemented using various additional and/or alternative components and/or arrangements that perform similar functions. Additionally or alternatively, it is recognized that in some arrangement, some various components may be omitted without frustrating the primary functionality of suction head assembly 9.

### Vacuum 4

Vacuum 4 is formed of any suitable size, shape, and design and are configured to transport air from suction head assembly 9 (e.g., via vacuum hose 11) to provide a vacuum to facilitate formation of a vacuum connection between suction head assembly 9 and photovoltaic panel 1. In some various arrangements vacuum 4 may be implementing using a commercially off the shelf vacuum or any alternative method or means for formation of a vacuum.

### Power Source 5

Power source 5 is formed of any suitable size, shape, and design and are configured to provide power to operate control system 10, vacuum, suction heat 9, lift assembly 3, and/or other components of system 100. In some various arrangements, power source 5 may include various different mechanical power source (electric motor (e.g., a DC motor or an AC motor) internal combustion engine, a fluid driven engine (e.g., steam, water, and/or air driven), or any other type of motor or engine), electrical power source (e.g. generators, batteries, photoelectric panels, thermoelectric devices), external power sources (e.g., infrastructure utility service, worksite generators, vehicle power supply), and/or any other method or means to provide power for operation of system 100.

### Control System 10

Control system 10 is formed of any suitable size, shape, design and is configured to control operation of various components of system 100, for example, in response to input from user interface 10.6. In the arrangement shown, as one example implementation, control system 10 includes a communication circuit 10.2, a processing circuit 10.3, and a memory 10.4 having software code 10.5 or instructions that facilitates the operation of system 100.

Processing circuit 10.3 may be any computing device that receives and processes information and outputs commands according to software code 10.5 stored in memory 10.4. For example, in some various arrangements, processing circuit 10.3 may be discreet logic circuits or programmable logic circuits configured for implementing these operations/activities, as shown in the figures and/or described in the specification. In certain arrangements, such a programmable circuit may include one or more programmable integrated circuits (e.g., field programmable gate arrays and/or programmable ICs). Additionally or alternatively, such a programmable circuit may include one or more processing circuits (e.g., a computer, microcontroller, system-on-chip, smart phone, server, and/or cloud computing resources). For instance, computer processing circuits may be programmed to execute a set (or sets) of software code stored in and accessible from memory 10.4. Memory 10.4 may be any form of information storage such as flash memory, ram memory, dram memory, a hard drive, or any other form of memory.

Processing circuit 10.3 and memory 10.4 may be formed of a single combined unit. Alternatively, processing circuit 10.3 and memory 10.4 may be formed of separate but electrically connected components. Alternatively, processing circuit 10.3 and memory 10.4 may each be formed of multiple separate but communicatively connected components.

Software code 10.5 is any form of instructions or rules that direct processing circuit 10.3 how to receive, interpret and respond to information to operate as described herein. Software code 10.5 or instructions is stored in memory 10.4 and accessible to processing circuit 10.3. As an illustrative example, in one or more arrangements, software code 10.5 or instructions may configure processing circuit 10.3 control system 10 to monitor user interface 10.6 and/or various sensors (not shown) of system 100 and perform various preprogramed actions in response to signals from user interface 10.6 and/or such sensors satisfying one or more trigger conditions.

As some illustrative examples, some actions that may be initiated by control system 10 in response to signals from sensors and/or user input from user interface 10.6 include but are not limited to, for example, controlling suction head assembly 9 and/or lift assembly 3 to facilitate connection with, moving, and/or repositioning photovoltaic panels I for installation.

Communication circuit 10.2 is formed of any suitable size, shape, design, technology, and in any arrangement and is configured to facilitate communication with devices to be controlled. monitored, and/or alerted by control system 300. In one or more arrangements, as one example, communication circuit 10.2 is a includes a transmitter (for one-way communication) or transceiver (for two-way communication). In various arrangements, communication circuit 10.2 may be configured to communicate with various components of system 10 using various wired and/or wireless communication technologies and protocols over various networks and/or mediums including but not limited to, for example, IsoBUS, Serial Data Interface 12 (SDI-12), UART, Serial Peripheral Interface, PCI/PCIe, Serial ATA, ARM Advanced Microcontroller Bus Architecture (AMBA), USB, Firewire, RFID, Near Field Communication (NFC), infrared and optical communication, 802.3/Ethernet, 802.11/WIFI, Wi-Max, Bluetooth, Bluetooth low energy. Ultra Wideband (UWB), 802.15.4/ZigBee. ZWave, GSM/EDGE, UMTS/HSPA+/HSDPA, CDMA. LTE, FM/VHF/UHF networks, and/or any other communication protocol, technology or network.

### User Interface 10.6

User interface 10.6 is formed of any suitable size, shape, design, technology, and in any arrangement and is configured to facilitate user control and/or adjustment of various components of system 10. In one or more arrangements, as one example, user interface 10.6 includes a set of inputs (not shown). Inputs are formed of any suitable size, shape, and design and are configured to facilitate user input of data and/or control commands. In various different arrangements, inputs may include various types of controls including but not limited to, for example, buttons, switches, dials, knobs, a keyboard, a mouse, a touch pad, a touchscreen, a joystick, a roller ball, or any other form of user input. Optionally. in one or more arrangements, user interface 10.6 includes a display (not shown). Display is formed of any suitable size, shape, design, technology, and in any arrangement and is configured to facilitate display information of settings, sensor readings, time elapsed, and/or other information pertaining to operation or system 100.

From the above discussion it will be appreciated that the system improves upon the state of the art. More specifically, and without limitation, it will be appreciated that in one or more arrangements an improved system for installation of photovoltaic panels is provided that assists in the movement and positioning of photovoltaic panels for mounting on support structures; that is efficient for installation; that can facilitate installation by a single person; that operably connects with photovoltaic panels using a vacuum connection; that is easy to use; that can be deployed on a transportation vehicle; that is configured to facilitate movement of photovoltaic panels from a rack in a transportation vehicle to a position adjacent support structures for installation; that is robust; that is durable; that has a long useful life; that works effectively; and/or that is high quality. These and other objects, features, or advantages of the disclosure will become apparent from the specification, figures and claims.

It will be appreciated by those skilled in the art that other various modifications could be made to the device without parting from the spirit and scope of this disclosure. All such modifications and changes fall within the scope of the claims and are intended to be covered thereby.

### SELECT REFERENCE NUMBERS

100—System
1—Photovoltaic Panels
2—Support Structure
2.1—Posts
2.2—Crossbar
2.3—brackets
3—Lift Assembly
4—Vacuum
5—Power Source
6.—Lifting Sleeve (of Lift Assembly 3)
7.—Pillar (of Lift Assembly 3)
8.—Arm/Rail (of Lift Assembly 3)
9—Suction Head Assembly
9.1—Rubber Seal
9.2—Docking System
9.3—Grip Handle
9.4—Clamping Bolt
9.5—Pneumatic Cylinder Base Support
9.6—Nozzle
9.7—Joint Support
9.8—Bearing Chamber
9.9—Bearing
9.10—Bearing Safe
9.11—Dowel Bolt
9.12—Metal Side Support
9.13—Metal Tilting Support
9.14—Cylinder Pin
9.15—Pneumatic Cylinder
9.16—Shank Hole
9.17—Swing arm bolt
9.18—Hub
9.19—Turning Plate
9.20—Packing
9.21—Fast Couplings
9.22—Hex head bolt
9.23—Rotor Disc
9.24—Rubber Stamp
9.25—Inner Bearing
9.26—Rubber Stamp
9.27—Key
9.28—Bearing Housing
9.29—Rubber Seal
9.30—Connection Plate
9.31—Head Turning Handle
9.32—Vacuum Chamber
9.33—Cylindrical Connector
9.34—Pneumatic Tubes
9.35—Support Structure
9.36—90 degree tubing connector 9.36
9.37—Suction Cups
9.38—Flexible Hose Connector
10—Control System
11.—Vacuum Hose
14.—Mobile Platform
14.1—Rack

What is claimed is:

1. A system for installation of photovoltaic panels, comprising:
a mobile platform;
a rack;
the rack operably connected to the mobile platform and configured to hold a plurality of photovoltaic panels;
a lift assembly;
the lift assembly operably connected to the mobile platform
a suction head assembly;
the suction head assembly operably connected to the lift assembly;
the suction head assembly configured to selectively connect with one of the plurality of photovoltaic panels in the rack;
the lift assembly configured to facilitate movement of the suction head to facilitate movement and positioning of the one of the plurality of photovoltaic panels from the rack to a position for installation.

2. The system of claim 1, wherein the lift assembly is configured to provide an upward counterbalance force to the suction head assembly when the suction head assembly is connected with one of the plurality of photovoltaic panels.

3. The system of claim 1, wherein the lift assembly includes a pillar, an arm, and a lifting sleeve;
wherein the arm operably connects the pillar to the lifting sleeve;
wherein the lifting sleeve is operably connected to the suction head assembly.

4. The system of claim 1, wherein the lift assembly includes a pillar, an arm, and a lifting sleeve;
wherein the arm operably connects the pillar to the lifting sleeve;
wherein the lifting sleeve is operably connected to the suction head assembly;
wherein the arm is configured to rotate about the pillar.

5. The system of claim 1, wherein the lift assembly includes a pillar, an arm, and a lifting sleeve;
wherein the arm operably connects the pillar to the lifting sleeve;
wherein the lifting sleeve is operably connected to the suction head assembly;
wherein the pillar, arm, and lifting sleeve are configured to work together to apply a lifting force to suction head assembly when attached to the one of the plurality of photovoltaic panels, so that the one of the plurality of photovoltaic panels is effectively weightless from the perspective of an installer.

6. The system of claim 1, wherein the suction head assembly includes a plurality of suction cups positioned in a plane;
wherein the suction head assembly is configured to apply a vacuum to is configured to apply a vacuum to the plurality of suction cups to facilitate connection of the suction head assembly with the a surface of the one of the plurality of photovoltaic panels.

7. The system of claim 1, further comprising a vacuum;
wherein the suction head assembly includes a plurality of suction cups positioned in a plane;
wherein the vacuum is fluidically connected to the plurality of suction cups by a flexible tube;
wherein operation of the suction causes the head assembly to apply a vacuum to the plurality of suction cups to facilitate connection of the suction head assembly with a surface of the one of the plurality of photovoltaic panels.

8. The system of claim 1, wherein the suction head assembly has a handle configured to facilitate repositioning of the suction head assembly and the one of the plurality of photovoltaic panels connected thereto.

9. The system of claim 1, wherein the suction head assembly is configured to pivot relative to the lift assembly.

10. The system of claim 1 further comprising a control system;
wherein the control system is configured to control operation of the lift assembly and suction head assembly in response to user input.
